(19) United States
(12) Patent Application Publication
(10) Pub. No.: US 2002/0085616 A1
(43) Pub. Date: Jul. 4, 2002

(54) Ear thermometer head

(75) Inventor: Chu-Yih Yu, San Chung City (TW)

Correspondence Address: DOUGHERTY & TROXELL, Suite 1404, 5205 Leesburg Pike, Falls Church, VA, 22041, US

(73) Assignee: MESURE TECHNOLOGY CO., LTD.

(21) Appl. No.: 09/753,546

(22) Filed: Jan. 4, 2001

(51) Int. Cl. G01J 5/02

(52) U.S. Cl. 374/158; 374/131

(57) ABSTRACT

An improved ear thermometer head includes a waveguide, a thermometer and a waveguide protective cover. The outer detecting end face of the waveguide protective cover is integrally formed and seamlessly connected to a transparent piece so that the outer detecting end face of the waveguide protective cover is in an enclosed and seamless state to shield an exposed clearance between the interior of the waveguide protective cover and the waveguide, thereby preventing entry of pollutants, such as water and dust. The outer detecting end face is substantially transparent, and is hardened and polished to effectively permit accurate light penetration. If there is water on the outer detecting end face or if it is dirty, it can be wiped clean, sterilized or washed. As such, the cleanliness and hygiene of the outer detecting end face of the waveguide protective cover is ensured, and besides, use of an additional cap to cover the waveguide protective cover is eliminated.

### BACKGROUND OF THE INVENTION

(a) Field of the Invention

The present invention relates to an improved ear thermometer head, more particularly to a waveguide protective cover having an enclosed and seamless outer detecting end face to prevent entry of water and dust, which can be wiped, sterilized and washed.

(b) Description of the Prior Art

Referring to FIGS. 1 and 2, a conventional ear thermometer head includes a waveguide 11′, a thermometer 12′, a waveguide protective cover 13′ and a thin film cap 14 14′. The waveguide protective cover 13′ is internally provided with a plurality of support ribs 131′ that support the waveguide 11′ such that a certain clearance is maintained between the waveguide 11′ and the waveguide protective cover 13′ to achieve heat insulation. The cap 14′ is fitted on the front end of the waveguide 11′ for light guidance. Since the cap 14′ is made of a very thin material, if dust gets inside and adheres to the surface of the cap 14′, the cap 14′ cannot be wiped clean for fear that it may be punctured or damaged. In other words, the cap 14′ is not strong enough to withstand washing and sterilization. But a dirty cap 14′ does not allow proper light penetration, which may affect the accuracy of temperature detection.

Therefore, in general, an ear thermometer is fitted with a replaceable cap 2. In addition to ensuring hygiene, the cap 2 can prevent entry of water or dust into the clearance between the protective cap 13′ and the waveguide 11′. Existing ear thermometer heads generally have exposed clearances, which have to be concealed by the caps 2. As such, there is an additional covering on the waveguide protective cover 13′. Since the cap 2 has folds, there may be improper light reflection when infrared lights from the waveguide 11′ penetrate two layers of coverings, which may affect the accuracy of temperature detection.

### SUMMARY OF THE INVENTION

The primary object of the invention is to provide an improved ear thermometer head in which an outer detecting end face of a waveguide protective cover is in an enclosed seamless state so that a clearance between the waveguide protective cover and a waveguide is concealed to prevent entry of pollutants, such as water and dust, into the clearance that serves to ensure heat insulation, thereby enhancing temperature detection accuracy.

Another object of the invention is to provide an improved ear thermometer head in which the outer detecting end face of the waveguide protective cover is hardened and polished so that it can effectively reflect light and can be wiped, sterilized, and washed when dirty so as to ensure hygiene and cleanliness of the waveguide protective cover.

A further object of the invention is to provide an improved ear thermometer head which, when adapted for personal use or for use by several family members, does not require use of a covering cap, thereby eliminating any environmental problem and the improper light reflection associated therewith. Besides, costs can be reduced.

Still another object of the invention is to provide an improved ear thermometer head in which a transparent piece is integrally formed or seamless connected to the outer detecting end face of the waveguide protective cover, thereby eliminating labor and costs associated with installing a thin film cap on the waveguide protective cover.

### BRIEF DESCRIPTION OF THE DRAWINGS

The foregoing and other features and advantages of the present invention will be more clearly understood from the following detailed description and the accompanying drawings, in which,

FIG. 1 is a schematic view of a conventional ear thermometer in a state of use;

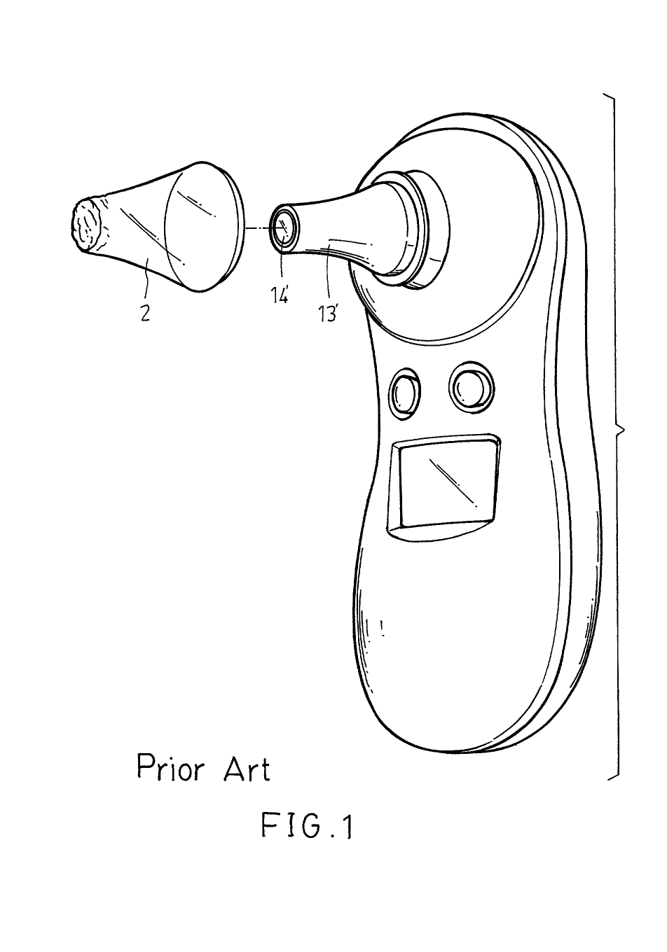

FIG. 2 is an exploded view of the conventional ear thermometer;

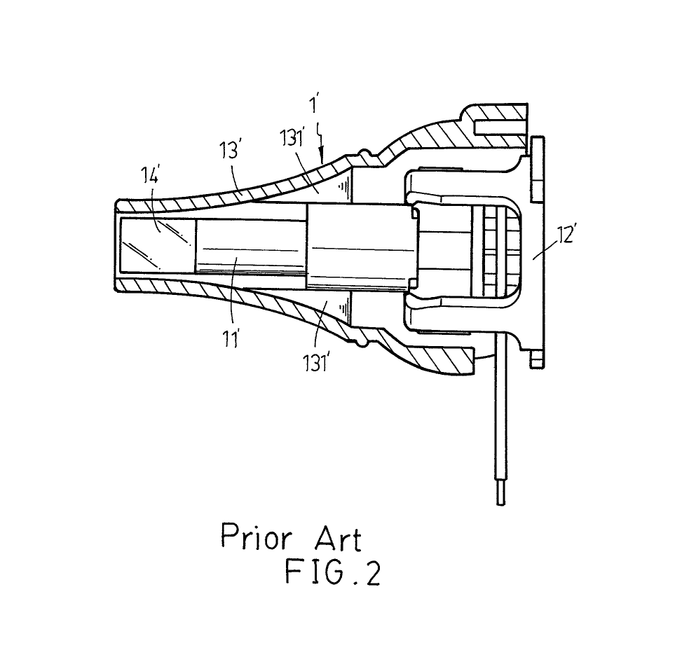

FIG. 3 is a perspective view of a preferred embodiment of the present invention coupled to an ear thermometer;

FIG. 4 is an exploded view of an ear thermometer head according to the present invention; and

FIG. 5 is a sectional view of the ear thermometer head according to the present invention.

### DETAILED DESCRIPTION OF THE PREFERRED EMBODIMENT

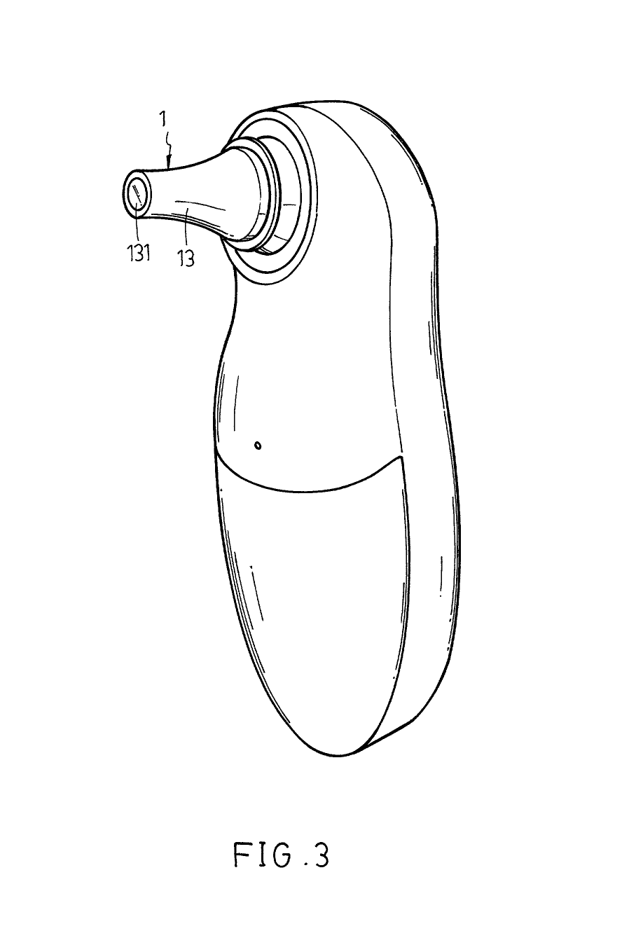

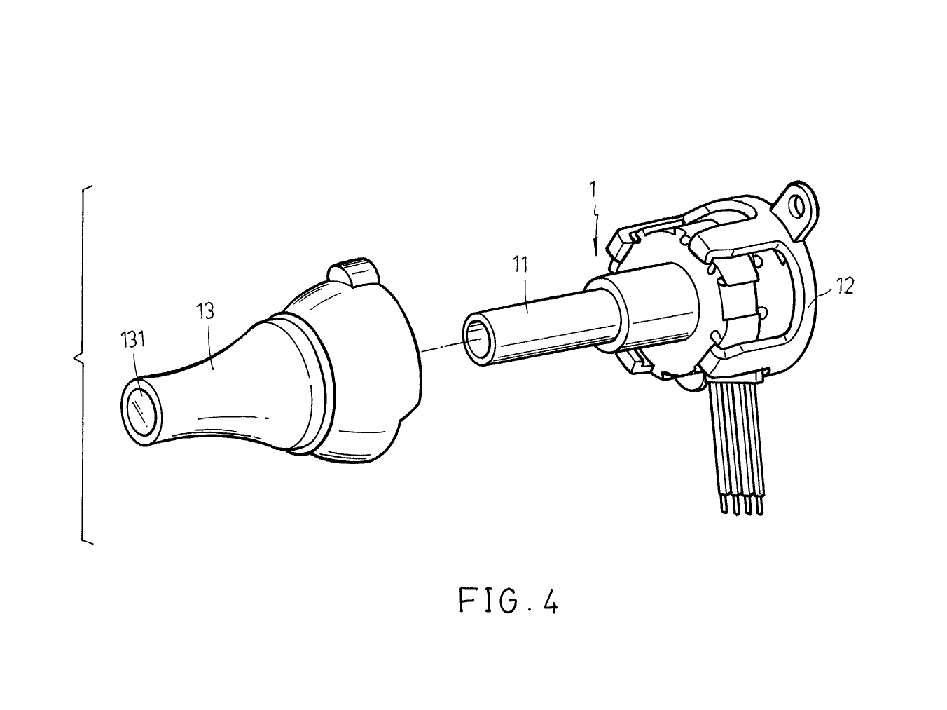

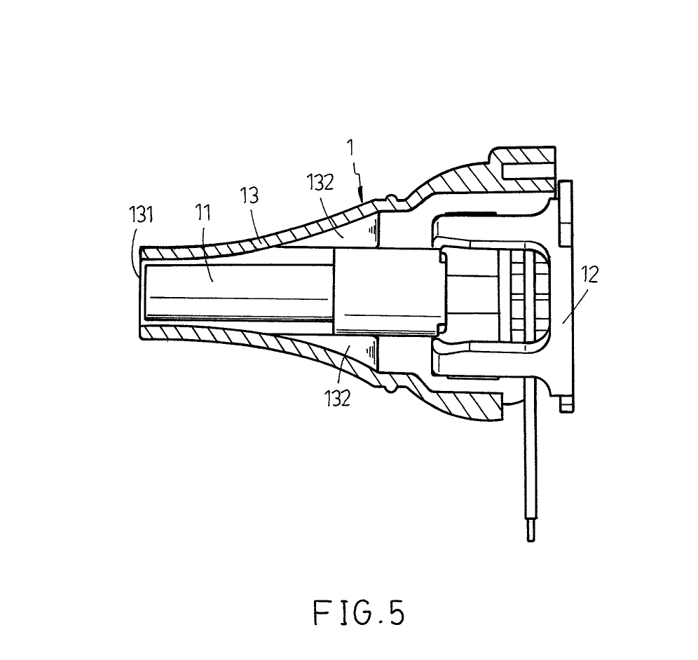

With reference to FIGS. 3 to 5, an ear thermometer head according to the present invention is shown to include a waveguide 11, a thermometer 12 and a waveguide protective cover 13. The infrared rays generated by the waveguide 11 penetrate an outer detecting end face 131 of the waveguide protective cover 13 to enable the thermometer 12 to detect an accurate body temperature value. The waveguide protective cover 13 is disposed on the outer portion of the waveguide 11, and is internally provided with a plurality of support ribs 132 for supporting the waveguide 11 such that a certain clearance is maintained between the waveguide protective cover 13 and the waveguide 11 for heat insulation so as to prevent inaccurate temperature detection. The outer detecting end face 131 of the waveguide protective cover 13 is integrally formed or seamlessly connected to a transparent piece such that the outer detecting end face 131 of the waveguide protective cover 131 is in an enclosed and seamless state to prevent entry of water or dust into the interior of the waveguide protective cover 13 and the clearance between the waveguide protective cover 13 and the waveguide 11, thereby preventing occurrence of heat conduction, which can affect accuracy of temperature detection.

The outer detecting end face 131 of the waveguide protective cover 13 is subjected to hardening and polishing so that it is rigid and is able to reflect light accurately. the surface of the outer detecting end face 131 of the waveguide protective cover 13 can be wiped clean, sterilized or washed when dirty, so as to maintain the cleanliness and hygiene of the waveguide protective cover 13. Hence, there is no need to provide a cover cap 2 on the waveguide protective cover 13 when the ear thermometer is adapted for use for personal use or for several family members. The elimination of use of the cover cap 2 is environmentally friendly, and besides, the problem associated with the improper reflection of light by the folds of the cover cap 2 can be overcome.

Although the present invention has been illustrated and described with reference to the preferred embodiment thereof, it should be understood that it is in no way limited to the details of such embodiment but is capable of numerous modifications within the scope of the appended claims.

What is claimed is:

1. An improved ear thermometer head, comprising a waveguide, a thermometer and a waveguide protective cover, said waveguide protective cover being internally provided with a plurality of support ribs for supporting said waveguide such that a certain clearance is maintained between said waveguide and said waveguide protective cover, wherein an outer detecting end face of said waveguide protective cover is integrally formed or seamlessly connected to a transparent piece so that said outer detecting end face of said waveguide protective cover is in an enclosed and seamless state, thereby preventing entry of water or dust and facilitating sterilizing, wiping and washing of said waveguide protective cover.
